(19) United States
(12) Patent Application Publication
(10) Pub. No.: US 2014/0279469 A1
(43) Pub. Date: Sep. 18, 2014

(54) SYSTEM AND METHOD FOR MOBILE TRANSACTION PAYMENTS

(71) Applicant: Rui Mendes, Oakville (CA)

(72) Inventor: Rui Mendes, Oakville (CA)

(73) Assignee: Carta Worldwide Inc., Oakville, ON (CA)

(21) Appl. No.: 13/795,371

(22) Filed: Mar. 12, 2013

(51) Int. Cl. G06Q 20/32

(52) U.S. Cl. CPC G06Q 20/32
USPC 705/41

(57) ABSTRACT

A method and system are disclosed for mobile transaction payments. A merchant device generates a machine-readable code containing merchant information and details of a transaction and displays this to a user device. The user device scans the code, or receives a message via NFC from the merchant device, to retrieve the transaction details and the merchant information. The user device then communicates this information, along with secure account information containing a virtual credit card or other payment type, to a merchant acquiring host, which processes the payment in association with an issuer host. Upon receipt of authorization from the issuer host, the merchant acquiring host informs both the merchant and the use of the status of the transaction.

### BACKGROUND

The subject disclosure is directed to the near field communications arts, the communications arts, the service providing arts, the radio communications arts, the mobile computing arts, transactional arts, point-of-sale arts, and the like.

Mobile payment generally refers to regulated financial services that are performed by or from a mobile device. Mobile payment is an alternative method of payment that, instead of using cash, checks, or credit cards, the user may use a mobile phone to pay for a wide range of goods and services. There are currently four models for conducting such mobile payments, SMS-based transactional payments, direct mobile billing, mobile web payments (using Wireless Application Protocol (WAP) technology), and contactless near field communications.

SMS-based transactional payments require a user of the mobile device to send an SMS text message or the like, to a short code and a resulting premium charge is added to the user's phone bill or online wallet (as described below). The merchant in the transaction is then informed of the success of the payment and may release the goods, perform the services, etc. Unfortunately, this type of mobile payment has poor reliability, is slow, provides minimal security, high start-up and operating costs, and the like.

Direct mobile billing generally involves a two-factor authentication (e.g., PIN and one-time-password) following which the user's mobile device account is charged for the purchase. Such payment is typical of payments made using mobile phones via ITUNES and ANDROID MARKET, e.g., payment for purchase of games, apps, music, etc. The security for such billing is higher than the SMS-based transactions, faster, convenient (no pre-registration, input of credit/debit cards), and easy (for online purchases). However, this method is limited to online purchases from the aforementioned sites or sites operated by the user's carrier. Additionally, already large carrier telephone bills may present a substantial shock to the user when such purchases are added.

Mobile web payments provide for the display and usage of web sites or downloaded applications to make payments to vendors. This type of operation inherently includes the benefits and disadvantages associated with web-based payments. For example, the user must still pre-register some form of credit card (unless directly billed to the carrier as set forth above); the process mirrors the typical online purchase format familiar to Internet users; if no pre-registration is available, the user must enter credit card information directly via the mobile device, which is prone to entry errors, and the like. Online wallets provided by PAYPAL, AMAZON PAYMENTS and GOOGLE CHECKOUT have mobile options, which involves online user registration. The user first provides a telephone number to one of the online wallet operators, whom then returns an SMS message having a PIN. The user then authenticates the number by entering the PIN and inputs credit card information or another payment method. Payments are then validated during a limited number of transactions. That is, the online wallets are useful for online purchases from a fixed location from online vendors. However, mobility is an issue as the online wallet is maintained by the providers and not on the mobile device, which is especially disadvantageous at a retail establishment that does not provide for online purchases.

Near field communications (“NFC”) is a set of standards for smartphones and similar portable user devices to establish radio communication with each other by touching them together or bringing them into close proximity, e.g., a few centimeters. The short-range wireless technologies employed in NFC operations typically require a distance of 10 cm or less. NFC requires an initiator and a target, with the initiator capable of actively generating an RF field that can power a passive target or communicate with an active target. NFC is generally used in physical transactions, wherein the vendor and the user are in close physical proximity, e.g., at retail establishments, transportation services, restaurants, and the like. This type of mobile payment requires a specially designed mobile device equipped with a smartcard that is “swiped” by holding the mobile device in close physical proximity to a card reader. The transaction in question may involve direct billing, PIN-based authentication, bank billing, pre-paid account, or the like. Unfortunately, this method requires a suitably equipped mobile device, as well as suitably equipped card readers at the point-of-sale. Widespread adoption of NFC has thus been hindered by users unwilling to purchase new phones equipped with NFC, vendors unwilling to purchase the equipment necessary to read NFC devices, mobile device manufacturers unwilling to incorporate additional features over which they have little control, etc.

A mobile wallet, in contrast to an online wallet, may include software, hardware, or a combination thereof, resident on a mobile device, that includes one or more linked accounts. However, current implementations of mobile wallets are based on specific infrastructure and/or network acceptance. For example, STARBUCKS mobile wallet is only accepted at their corresponding coffee establishments, PAYPAL is only accepted when online merchants connect to PAYPAL, GOOGLE CHECKOUT (mobile wallet variant) only works if you use a CITIBANK credit card, in a specific region, and using a specific device.

QUICK RESPONSE (QR) codes is a type of matrix barcode, two-dimensional bar code that constitutes a type of machine-readable code. QR codes are generally capable of encoding a greater quantity of data than a typical barcode, and are associated with a faster response time. Current smartphones include both rear and front facing cameras, with the various operating systems having applications that allow for scanning and reading of these codes, which are becoming prevalent at restaurants, stores, and online. The code itself may be represented by a white square having a pattern of black squares located thereon encoding the desired information. The types of information capable of being encoded range from numeric, alphanumeric, binary and may further be extended to other types of data. Some applications of such QR codes include transportation ticketing, metadata, product information, and the like.

Current implementations of NFC mobile payments require the communication from a user's mobile device of payment information to a merchant device. The merchant device is then tasked with contacting a merchant acquiring host (payment processor) to facilitate completion of a transaction. This communication of secure account information represents a possible threat to security, as the credit card number is communicated to the merchant, leaving the user without control of secure information. For example, an employee of the merchant may steal this credit card number during checkout, without the user ever realizing until made aware of the theft via bank or credit card statement. Even requiring the use of a PIN to send the credit card information to the merchant device does not stop the theft, as the PIN is only entered on the user's mobile device and is not transmitted, or if it does, it just adds another point for possible theft to occur. Furthermore, credit card issuers or banks are typically met with the user denying transactions, stating that it was a stolen number even when no such theft occurred.

Thus, it would advantageous to provide a system and method for secure mobile transaction payments that do not require the transmission of secure account information from the user to the merchant, but still enable completion of a transaction between the user and the merchant.

### INCORPORATION BY REFERENCE

The following reference, the disclosure of which is incorporated herein by reference, in their entirety, is mentioned.

U.S. patent application Ser. No. 13/533,057, filed Jun. 26, 2012, entitled MOBILE WALLET PAYMENT PROCESSING, by Rui Mendes.

### BRIEF DESCRIPTION

In one aspect of the exemplary embodiment, a method for mobile transaction payments, which includes receiving, by a user device, merchant information and transaction details corresponding to a transaction between an associated merchant and an associated user. The method further includes generating a merchant acquiring message inclusive of the transaction details, the merchant information, and account holder secure information corresponding to the associated user. The method also includes communicating the merchant acquiring message to a merchant acquiring host via an associated computer network. In addition, the mobile transaction payment method includes receiving a response from the merchant acquiring host corresponding to at least one of an authorization or denial of the transaction. The method also includes displaying, via an associated display, a status of the transaction in accordance with the received authorization or denial of the transaction. The receiving, generating, communicating, receiving, or displaying is performed with a computer processor of the user device.

In another aspect, a mobile transaction payment system includes a merchant acquiring host. The merchant acquiring host includes an authorization request component that is configured to generate an authorization request to an associated issuer host for a transaction between an associated merchant device and an associated user device. The merchant acquiring host further includes memory that stores instructions for receiving a merchant acquiring message from the associated user device. The merchant acquiring message includes transaction details, merchant information and account holder secure information. The instructions are also for identifying the associated issuer host in accordance with the account holder secure information of the merchant acquiring message. Additionally, the instructions stored in memory are for generating the authorization request to the identified issuer host, which request corresponds to the transaction details, merchant information, and account holder secure information. The instructions are also for communicating the authorization or the denial of the transaction associated with the transaction details to the associated merchant device and the associated user device. The system also includes a processor in communication with the memory that executes the instructions.

In another aspect, a computer-implemented mobile payment transaction method that includes collecting, by a merchant device having a processor and memory storing merchant information corresponding to an associated merchant, at least one transaction detail corresponding to a transaction between the associated merchant and an associated user. The method further includes generating a machine-readable code corresponding to the at least one collected transaction detail and the merchant information, and displaying the generated machine-readable code via an associated display. In addition, the method includes receiving an authorization or a denial of the transaction from an associated merchant acquiring host, and displaying the status of the transaction.

### BRIEF DESCRIPTION OF THE DRAWINGS

FIG. 1 is a functional block diagram of a system for mobile transaction payments in accordance with one aspect of the exemplary embodiment.

FIG. 2 is a functional block diagram of an example merchant device used in the system for mobile transaction payments in accordance with one aspect of the exemplary embodiment.

FIG. 3 is a functional block diagram of an example user device used in the system for mobile transaction payments in accordance with one aspect of the exemplary embodiment.

FIG. 4 is a flowchart that illustrates one aspect of the method for mobile transaction payment associated with a merchant device according to an exemplary embodiment.

FIG. 5 is a flowchart that illustrates another aspect of the method for mobile transaction payment associated with a user device according to an exemplary embodiment.

FIG. 6 is a flowchart that illustrates another aspect of the method for mobile transaction payment associated with the merchant device according to an exemplary embodiment.

FIG. 7 is a flowchart that illustrates another aspect of the method for mobile transaction payment associated with the user device according to an exemplary embodiment.

FIG. 8 is a flowchart that illustrates another aspect of the method for mobile transaction payment associated with a merchant acquiring host according to an exemplary embodiment.

FIG. 9 is a flowchart that illustrates another aspect of the method for mobile transaction payment associated with an issuer host according to an exemplary embodiment.

### DETAILED DESCRIPTION

One or more embodiments will now be described with reference to the attached drawings, wherein like reference numerals are used to refer to like elements throughout.

In one aspect, a system and method provides enhanced security for mobile payment processing by allowing the user device to communicate the transaction and payment details to a merchant acquiring host for processing, thereby avoiding transmission of payment information directly to merchants. That is, the system and method disclosed herein enables a user device to render payment for goods or services to a merchant without requiring the user device to disclose credit card or other personal information to the merchant to complete the transaction.

It will be appreciated that the systems and methods described herein enable the utilization of a secure ecosystem wherein encrypted (encoded) messages may be exchanged between devices, with transactions split in content and authorization, and where settlements of transactions take place in real time. It will further be appreciated that the subject systems and methods enable individuals and merchants to respectively pay and receive money without the need of external payment devices, e.g., credit card readers, etc. Furthermore, it will be appreciated that the systems and methods described hereinafter allows for the total validation of electronic commerce transactions by substantially reducing purchaser denial fraud. In embodiments contemplated utilizing the subject systems and methods, a bridge is provided between open and closed loop networks and may be integrated with near field communication payments on supporting devices.

As used herein, a “merchant” denotes an individual or establishment that offers goods or services for sale to customers, such as a store, retailer, vendor, restaurant, service provider, etc.

“User” denotes an individual who is a customer of the system associated with a “user device” and conducting a transaction with a “merchant.”

“Merchant device” denotes a device owned by the merchant and able to initiate an “application” for interacting with the system for mobile transaction payments. Examples of such a merchant device include, without limitation, mobile phones, personal data assistants, tablets, point-of-sale devices, computer workstations, registers, and other electronic devices. An exemplary merchant device is illustrated and discussed with respect to FIG. 3 below.

“User device” or “mobile device” denotes a device owned by the user and able to initiate an “application” for interacting with the system for mobile transaction payments. Examples of such a user device include, without limitation, mobile phones, personal data assistants, tablets, and other personal electronic devices. The user device may include a camera or other image-capturing component that is capable of scanning and capturing machine-readable code. The user device may be NFC-enabled, as well as capable of data communication with one or more wired or wireless networks, as discussed with respect to FIG. 4 below.

“Merchant acquiring host” denotes the server or servers in communication with the merchant device, the user device, and an “issuer host.” The merchant acquiring host may include various components, as illustrated in FIG. 1, configured to interact with and facilitate completion of transactions associated with the mobile transaction payment systems and methods described hereinafter.

“Issuer host” denotes the server or servers in communication with the merchant device, the user device, and a merchant acquiring host. The issuer host may include various components, as illustrated in FIG. 1, configured to issue and settle accounts amongst the merchants and users of the mobile transaction payment systems and methods described hereinafter.

In one aspect, a merchant device, such as a point-of-sale device, mobile device, etc., enables the merchant to install an application that includes a code generator for generating a machine-readable code, such as a quick response (QR) code, a DataGlyph, or other such code, that includes merchant identification and details of a transaction with a user. This code may then be displayed on a display associated with the merchant device and thus made available to be scanned, i.e., read, by a user device. The merchant device may also include a close proximity communications component, such as Near Field Communications (NFC), to enable the transmission of transaction details from the merchant device to an associated user device. In other embodiments, the merchant device may utilize applications that detect the presence of a user device and communicate details to a corresponding application on the user device via a computer network, such as the Internet, either directly or via a third party server.

One aspect of the system and method may provide an application for installation on a user device, such as a mobile communications device, tablet, personal computer, etc., that includes access to a mobile wallet. The application installed on the user device may include a decoder that is operable to read and decode a machine-readable code displayed by the merchant device. The user device may also include a close proximity communications component that is capable of receiving transaction details from the merchant device. The application resident on the user device may further include access to a mobile wallet, utilizing a credit card account, a virtual credit card, a debit account, or the like, which is adapted to facilitate payment for transactions. The application may further include a merchant acquiring message generator that generates a message, which includes the transaction details and payment information for communication to a merchant acquiring host for processing. During setup of the application, a virtual credit card may be created by an issuer host, as set forth in U.S. application Ser. No. 13/533,057, filed Jun. 26, 2012 and titled MOBILE WALLET PAYMENT PROCESSING, the entirety of which is incorporated by reference herein.

Another aspect of the system and method described herein may further provide for a merchant acquiring host to facilitate the completion of the transaction between the merchant device and the user device. The merchant acquiring host may receive transaction details and payment information from the user device and request authorization from an issuer host, which may be selected during setup of the respective applications on the merchant device and the user device. Upon receipt of merchant acquiring message, the merchant acquiring host may parse the amounts due and payment information and contact the issuer host seeking authorization for the transaction. The issuer host may then approve the transaction, thereafter transferring payment from the issuer to the merchant and return this approval to the merchant acquiring host. The issuer host may debit or charge a payment source selected by the user during installation of the application on the user device prior to settling payment due the merchant. The merchant acquiring host may then communicate authorization (approval) or denial of the transaction to both the merchant device and the user device to complete or deny the transaction.

It will be appreciated that the systems and methods set forth herein are independent from cellular telephone manufacturers, cellular phone network operators, and cellular phone operating systems, based upon the use of certain machine-readable codes and/or the NFC standard. Additionally, the systems and methods need not be dependent upon the SIM card capability and of mobile phone security services (e.g., GOOGLEWALLET). In some embodiments, the SIM Secure Element (SE) or the SE on the mobile device itself may be utilized to provide additional security. The systems and methods further provide robust interoperability for the user between multiple service providers utilizing the same application, with the user and merchant able to complete transactions using their respective devices. Thus, the subject systems and methods set forth herein provide greater security in mobile payment applications, and allow for payment from a user device to a merchant via a merchant's mobile device, a merchant's point-of-sale device, web-based merchant transactions, and the like. The systems and methods further provide robust interoperability for the user device between multiple service providers, e.g., cellular telephone carriers, etc., with the user only having to register with the merchant acquiring host and conducting all payments through this host, with no payment information transferred to the merchant itself.

It will further be appreciated that while illustrated in FIG. 1 as implemented in a merchant system, e.g., a physical storefront, the systems and methods set forth hereinafter are equally adaptable and contemplated to extend to any merchant providing goods or services to users. For example, the system may be implemented to enable transactions in a variety of environments, e.g., facilitate payment at restaurants, parking lots, taxi services, airports, online shopping, sports venues, movie theaters, and the like. Accordingly, it will be appreciated that myriad environments are capable of utilizing the systems and methods now set forth.

Referring now to FIG. 1, there is shown a secure mobile transaction payment system 100 configured for providing mobile payment functionality with high levels of security for transactions between users and merchants. FIG. 1 illustrates an example implementation in the form of a transaction between a merchant device 102 and a user device 104. Other embodiments may include implementation utilizing the user device 104 and a web site hosted for the merchant. It will be appreciated that the various components depicted in FIG. 1 are for purposes of illustrating aspects of the exemplary embodiment, and that other similar components, implemented via hardware, software, or a combination thereof, are capable of being substituted therein.

As shown in FIG. 1, the secure mobile transaction payment system 100 for providing mobile payment functionality includes a merchant device 102, described in greater detail in FIG. 2, a user device 104 described in greater detail in FIG. 3, a merchant acquiring host 106, and an issuer host 108. It will be appreciated that the system 100 for secure mobile transaction payment is capable of implementation using a distributed computing environment, such as the computer network 110 depicted in FIG. 1, which is representative of any distributed communications system capable of enabling the exchange of data between two or more electronic devices, e.g., the devices 102-108. It will be further appreciated that such a computer network includes, for example and without limitation, a virtual local area network, a wide area network, a personal area network, a local area network, the Internet, an intranet, or the any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 1 as a networked set of components, the system and method are capable of implementation on a stand-alone device adapted to perform the methods described herein.

The merchant device 102 depicted in FIG. 1 may be configured to implement the exemplary method described below. An exemplary block diagram of a suitable merchant device 102 is shown in FIG. 2. The merchant device 102 may include a computer server, workstation, personal computer, cellular telephone, tablet computer, pager, a point-of-sale device, a hosted website associated with the merchant for online sales, a combination thereof, or other computing device capable of executing instructions for performing the exemplary method. Thus, the exemplary merchant device 102 is depicted in FIG. 2 to illustrate one example implementation and various other components may be used, substituted, and the like. The exemplary merchant device 102 includes a processor 202, which performs the exemplary method by execution of processing instructions 204 that are stored in memory 206 connected to the processor 202, as well as controlling the overall operation of the merchant device 102.

According to one example embodiment, the merchant device 102 includes hardware, software, and/or any suitable combination thereof, configured to interact with an associated user, a networked device, networked storage, remote devices, or the like.

The various components of the merchant device 102 may all be connected by a data/control bus 208. The merchant device 102 may include one or more input/output (I/O) interface devices 210 and 212 for communicating with external devices. The I/O interface 212 may communicate, via communications link 228, with one or more of a display device 214, for displaying information, such as transaction status information, transaction details 224, machine readable code 226, and a user input device 216, such as a keyboard or touch or writable screen, for inputting text, and/or a cursor control device, such as mouse, trackball, or the like, for communicating user input information and command selections to the processor 202. The I/O interface 210 may communicate, via communications link 112, with a computer network 110 enabling communication with the merchant acquiring host 106, the issuer host 108, and other devices in communication with the computer network 110.

The memory 206 may represent any type of non-transitory computer readable medium such as random access memory (RAM), read only memory (ROM), magnetic disk or tape, optical disk, flash memory, or holographic memory. In one embodiment, the memory 206 comprises a combination of random access memory and read only memory. In some embodiments, the processor 202 and memory 206 may be combined in a single chip. The network interface(s) 210, 212 allow the computer to communicate with other devices via a computer network, and may comprise a modulator/demodulator (MODEM). Memory 206 may store the data processed in the method as well as the instructions for performing the exemplary method.

The digital processor 202 can be variously embodied, such as by a single core processor, a dual core processor (or more generally by a multiple core processor), a digital processor and cooperating math coprocessor, a digital controller, or the like. The digital processor 202, in addition to controlling the operation of the merchant device 102, executes instructions 204 stored in memory 206 for performing the method outlined in FIGS. 4-9.

As depicted in FIG. 2, the instructions 204 may include a merchant application 218 that is configured to facilitate interactions with the user device 104, a merchant acquiring host 106, an issuer host 108, and the like, as discussed in greater detail below. According to one embodiment, the merchant application 218 may be downloaded from the merchant acquiring host 106 and installed in memory 204 of the merchant device 102. The merchant application 218 may be customized for the specific merchant device 102 or merchant type (e.g., store, restaurant, etc.) associated therewith. The merchant application 218 may include one or more components operable to allow the merchant device 102 to interact with a user device 104, the merchant acquiring host 106, the issuer host 108, and the like.

The merchant application 218 stored in the instructions 204 of the merchant device 102 may further a code generator 220. The code generator, in accordance with one embodiment, is configured to generate a machine-readable code 226 corresponding to transaction details 224 associated with a transaction between the merchant device 102 and the user device 104. It will be appreciated that the machine-readable code 226 may be a bar code, QR code, DatGlyph, or other such code, and the illustration of the machine-readable code 226 in FIG. 2 is for purposes of illustration of a suitable machine-readable code contemplated hereunder. In some embodiments, the code 226 may include a timestamp, hash, the transaction details 224 (e.g., cost, items, totals, taxes, location, store number, etc.), merchant information 230 (e.g., merchant name, merchant type, other identifying information, etc.), and other information associated with the transaction between the merchant device 102 and the user device 104. The code 226 may be communicated via the communications link 228 to the display 214 for reading/scanning by the user device 104, as discussed in greater detail below.

The merchant application 218 stored in the instructions 204 may further include a transaction message generator 222 that is capable of generating a transaction message 113 that includes transaction details 224, merchant information 230, any additional fields (e.g., tips, etc.), and the like. In one embodiment, the transaction message generator 218 may be utilized to send, via a short-range communication link 111, a transaction message 113 to an associated user device 104. Suitable short-range communication links include, for example and without limitation, a proprietary interface, NFC, infrared, BLUETOOTH, and the like. In some embodiments, the merchant device 102 may communicate using the short-range communication link 113 via an established personal area network.

Returning to FIG. 1, the secure mobile transaction payment system 100 may include a user device 102 that is capable of communication with the merchant device 102 via a communication link 111, and the network 110 via a communications link 114. The user device may further be in intermittent or continuous contact with the merchant acquiring host 106 and/or issuer host 108 during setup of the device 104 or during transactions with the merchant device 102. In some embodiments, the user device 104 may utilize opportunistic communications with the merchant acquiring host 106, such as when a cellular or data network is available. In one embodiment, the user device 104 may be implemented as a smartphone employing an operating system such as iOS, ANDROID, BLACKBERRY, WINDOWS, or the like, or any device having NFC capabilities.

The user device 104 is representative of any personal computing devices, such as personal computers, netbook computers, laptop computers, workstation computers, personal data assistants, web-enabled cellular telephones, tablet computers, proprietary network devices, or other web-enabled electronic devices. The data communications link 114 between the user device 104 and the network 110 may be accomplished via any suitable channel of data communications such as wireless communications, for example Bluetooth, WiMax, 802.11a, 802.11b, 802.11g, 802.11(x), a proprietary communications network, infrared, optical, the public switched telephone network, cellular data network, e.g., 3^{rd} generation mobile phone standards (3G), 4^{th} generation standards (4G, 4G LTE, WiMax), EV-DO, standalone data protocols, or any suitable wireless data transmission system, or wired communications. In one embodiment, the user device 104 may communicate with the network 110 via a cellular data network.

FIG. 3 provides an example illustration of a user device 104 depicted in FIG. 1. The user device 104 may include a processor 302, which executes one or more instructions or user applications 316 in the performance of an exemplary method discussed below. The user device 104 may further include a memory 304 storing the user application 316 in data communication with the processor 302 via a system bus 306. The processor 302 of the user device 104 may be in data communication with the merchant device 102 via an I/O interface 312 and merchant acquiring host 106 and issuer host 108 via communications link 114 to the network 110 utilizing an I/O interface 310.

In one embodiment, the I/O interface 312 is implemented as a short-range communication component, such as, for example an NFC component. In such an embodiment, the I/O interface 312 may be implemented using any suitable short-range communications protocol, and the use of NFC protocols is for example purposes only. The user device 104 may further include a display 308 suitably configured to display data to an associated user, receive input from the associated user, and the like. In some embodiments, the display 308 of the user device 104 may be configured as a touch-screen display capable of receiving user instructions via user contact on the display, e.g., LCD, AMOLED, LED, RETINA, etc., types of touch-screen displays.

The memory 304 may represent any type of non-transitory computer readable medium such as random access memory (RAM), read only memory (ROM), magnetic disk or tape, optical disk, flash memory, or holographic memory.

In one embodiment, the memory 304 comprises a combination of random access memory and read only memory. In some embodiments, the processor 302 and memory 304 may be combined in a single chip. The network interface(s) 310, 312 allow the user device 104 to communicate with other devices via a communications network, and may comprise a modulator/demodulator (MODEM). Memory 304 may store data the processed in the method as well as the instructions for performing the exemplary method. The digital processor 302 can be variously embodied, such as by a single core processor, a dual core processor (or more generally by a multiple core processor), a digital processor and cooperating math coprocessor, a digital controller, or the like.

The user device 104 depicted in FIG. 3 may further include an image capture component 314 in data communication with the processor 302 via the system bus 306. The image capture component 314 may be any suitable component capable of capturing an image of, for example, a displayed machine-readable code 226. Suitable examples of such image capture components include, for example and without limitation, digital camera components, CMOS image sensors, CCD type cameras, video cameras, and the like, of various resolution capabilities and speeds, as will be appreciated. In some embodiments contemplated herein, the image capture component 314 is further in communication with a decoder component 318 of the user application 316, as discussed in greater detail below. According to one embodiment, the image capture component 314 is configured to capture an image of the machine-readable code 226 in sufficient resolution and detail to enable operation of the decoder 318 thereon.

The memory 304 of the user device 104 includes the user application 316 received from the issuer host 101 during registration of the user device 104, as discussed below with respect to FIGS. 4-9. The user application 316 stored in memory 304 may include the decoder component 318, which is configured to read and analyze a machine-readable code 226 displayed via the display 214 of the merchant device 102 and captured via the image capture component 314.

The user application 316 stored in memory 304 may include account holder secure information 320 including a mobile wallet 322, such as that described in U.S. patent application Ser. No. 13/533,057, as incorporated above. Such a mobile wallet 322 may store, for example and without limitation, information related to a virtual credit card 326, a predefined funding source 324, and the like. In accordance with one embodiment, the mobile wallet 322 may be downloaded or retrieved from the issuer host 108 and operable in the memory 304 of the user device 104, or may be installed as specific hardware in the user device 104. As illustrated in FIG. 1, the mobile wallet 322 may include a virtual credit card 326, which may be issued on the fly during a transaction, issued by the issuer host 108 during set up and registration of the user application 316, upon request from a user associated with the user device 104, or the like. The virtual credit card 326 may correspond to a credit card, a charge card, or prepaid card issued by the issuer host 108 in association with MASTERCARD, VISA, DISCOVER CARD, AMERICAN EXPRESS, etc., rules and regulations. Accordingly, the mobile wallet 116 may further store one or more transaction rules or regulations 327 associated with the virtual credit card 326, operation of the mobile wallet 322, instructions for processing transactions with merchant device 102 or merchant acquiring host 106, and the like. For example, the transaction rules 327 may include special handling instructions for certain vendors, products, services, locations, etc., which may indicate the type of payment to use, type of authorization, type of validation, type of user identification (e.g., PIN, social security number, mother's maiden name, etc.), and the like.

The mobile wallet 322 may also include some form of predefined funding source 324, i.e., a credit card account, checking account, savings account, a charge card account, debit card account, etc., associated with the user that is provided by a bank, a financing company, a governmental entity, the issuer host 108, or the like. According to one embodiment, the predefined funding source 324 may be used to fund or “top-up” the virtual credit card 326. The account holder secure information 320, which may be used to identify/authenticate the user and account(s) associated with the user device 104, may be communicated to the issuer host 108 during installation of the user application 316 on the user device 104, a registration process associated with the user device 104, provided by the user during association of the predefined funding source 324, or the like. In addition, some or all of the account holder secure information 320 may be required during the processing of a transaction with the merchant device 102 and the merchant acquiring host 106, as discussed in greater detail below.

The user application 316 may further include a merchant acquiring host message generator 328 that is configured to generate a message 330 during the conduction of a transaction with the merchant device 102. In one embodiment, the generator 328 may combine transaction details 224 with the account holder secure information 320, merchant information 230, and the like into a merchant acquiring message 330 for communication via the communications link 114 to the merchant acquiring host 106 over the computer network 110. In such an embodiment, the account holder secure information 320 may include the virtual credit card 326 and other identifying indicia associated with the user. It will be appreciated that other account holder secure information, e.g., rules 327, funding source 324, wallet 322, would not be included in the message 330 to the merchant acquiring host 106. The message 330 may further include additional information associated with the transaction, e.g., taxes, tips, and the like, which are also communicated to the merchant acquiring host 106.

During completion of a transaction between the user device 104 and the merchant device 102, the user may bring the user device 104 into proximity with the merchant device 102 so as to establish an NFC or other close-proximity data link. The merchant device 102 may then communicate transaction message 113 to the user device 104, which then generates a merchant acquiring message 330 for completing the transaction. For example, other proximity data links may be used such as Bluetooth, wherein the merchant device 102 is presented with a list of user devices 104 in physical proximity thereto, prompting the merchant associated with the merchant device 102 to select the appropriate user device 104. The merchant device 102 may then communicate the transaction message 113 to the selected user device 102.

In another example implementation, the list of user devices 104 presented to the merchant may correspond to those user devices 104 that have notified a backend component (e.g., merchant acquiring host 106, issuer host 108, or other device) of their respective geophysical locations, which correspond to the physical location of the merchant device 102. The merchant device 102 may then communicate the transaction message 113 directly via a communications link with the user device 104 directly (link 111) or indirectly through the network 110 to the backend component (106, 108, or other device), which then forwards the transaction message 113 to the user device 104 via the communications link 114.

In another embodiment, the user may initiate the user application 316, which causes the image capture component 314 to capture a code 226 displayed by the merchant device 102. The user application 316, in accordance with operation of the processor 302, then uses the decoder 318 to decode the transaction details 224 from the code 226 and generates the merchant acquiring message 330 for subsequent communication to the merchant acquiring host 106, as discussed below.

Returning to FIG. 1, the system 100 for secure mobile transaction payments further includes a merchant acquiring host 106 in data communication with the merchant device 102, the user device 104, and the issuer host 108 via its communication link 116 to the computer network 110. As depicted in FIG. 1, the merchant acquiring host 106 facilitates the completion of a transaction for goods or services between the merchant device 102 and the user device 104. The merchant acquiring host 106 may be implemented as a computer server, workstation, personal computer, cellular telephone, tablet computer, pager, combination thereof, or other computing device capable of executing instructions for performing the exemplary method. According to one example embodiment, the merchant acquiring host 106 includes hardware, software, and/or any suitable combination thereof, configured to interact with an associated user, a networked device, networked storage, remote devices, or the like.

The exemplary merchant acquiring host 106 includes a processor 120, which performs the exemplary method by execution of processing instructions 124 that are stored in memory 122 connected to the processor 120, as well as controlling the overall operation of the merchant acquiring host 106.

The instructions 124 include an authorization request component 138 configured to request authorization for the transaction from the issuer host 108 in accordance with the transaction details 230 received from the user device 104 in the merchant acquiring message 330. The authorization request component 138 may generate a request for authorization 139 that includes some or all of the transaction details 230. In one embodiment, such an authorization request 139 includes the merchant information 230, select account holder secure information 320 and at least the amount to be paid by the user device 104 to the merchant device 102. The authorization request from the authorization request component 138 may be communicated over via the communications link 116 over the computer network 110 to the issuer host 108, via a direct connection (not shown) to the issuer host 108, or the like. It will be appreciated that in some embodiments, the merchant acquiring host 106 and the issuer host 108 may be the same entity, hosted on the same device, or the like. Accordingly, it will be appreciated that the depiction of separate devices 106 and 108 are used herein to illustrate one particular implementation of the subject systems and methods.

The instructions 124 stored in memory 122 may further include a transaction status component 140 that is configured to receive authorization or denial from the issuer host 108 and communication transaction status 142 to the merchant device 102 and the user device 104 via the computer network 110. In one embodiment, the status component 140 is configured to generate a message that notifies the merchant device 102 and the user device 104 of the acceptance, rejection, or pendency of the transaction. In some embodiments, the transaction status 142 may be updated and communicated in varying iterations to reflect the most current status of the transaction, e.g., transaction status 142 may indicate approval, denial, pending, communicating with host, etc.

The various components of the merchant acquiring host 106 may all be connected by a data/control bus 126. The merchant acquiring host 106 may include one or more input/output (I/O) interface devices 128 and 130 for communicating with external devices. The I/O interface 128 may communicate, via communications link 132, with one or more of a display device 134, for displaying information and a user input device 136, such as a keyboard or touch or writable screen, for inputting text, and/or a cursor control device, such as mouse, trackball, or the like, for communicating user input information and command selections to the processor 120.

The system 100 illustrated in FIG. 1, may further include an issuer host 108 associated with an issuing entity that is in data communication with the computer network 110 via a communications link 118. The issuer host 108 may include a processor 144 that is capable of implementing a portion of the exemplary method described below by executing one or more instructions 148 stored in memory 146 communicatively coupled to the processor 144 via a system bus 154. The processor 144 may be implemented to control overall operations of the issuer host 108.

It will be appreciated that the issuer host 108 is representative of a computing device that is capable of facilitating interaction among disparate other computing devices in data communication therewith, such as, for example and without limitation, the merchant device 102, the user device 104, the merchant acquiring host 106, and the like. In accordance with one embodiment, the issuer host 108 is capable of being employed as one possible hardware configuration to support the systems and methods described herein. Accordingly, although the issuer host 108 is illustrated as a standalone computing device, any suitable computing environment is may be employed. For example, computing architectures including, but not limited to, multiprocessor, distributed, tablet, mainframe, supercomputer, digital and analog can be employed in accordance with varying embodiments set forth herein. It will further be appreciated that the issuer host 108 may include computer workstations, personal computers, combinations thereof, or any other computing devices.

The memory 146 may store the merchant application 218 and the user application 316 for communication to respective merchant devices 102 and user devices 104 during installation and registration of the applications 218 and 316 on the respective devices 102 and 104.

The instructions 148 stored in memory 146 may include an authorization component 152 that is configured to respond to an authorization request 139 received from the merchant acquiring host 106 corresponding to a transaction between the merchant device 102 and the user device 104. The authorization component 152 may generate messages to the merchant acquiring host 106 in response to a request for authorization, which messages may include details associated with approval, e.g., confirmation codes, approval message, etc., or denial, e.g., insufficient funds, stolen account, etc.

The instructions 148 may further include a virtual credit card issuing component 153, that is configured to issue credit cards, prepaid cards, and the like, in accordance with rules and regulations established by MASTERCARD, VISA, DISCOVER CARD, AMERICAN EXPRESS, or the like. The virtual credit card issuing component 153 of the issuer host 108 may further be configured to generate, i.e., issue, credit cards, encrypt data associated with a user or account on credit cards or associated semiconductor chips, perform the card monetary authorizations and facilitate the settling of funds with all parties involved, e.g., a merchant device 102, the user device 104, the merchant acquiring host 106, etc. The issuer host 108 is illustrated in FIG. 1 as a server for example purposes only, and it will be appreciated that any suitable hardware, software, or combinations thereof, are capable of assisting in the issuance of virtual credit cards 322, approval or denial of transactions, and settling of merchant accounts 170, as set forth in greater detail below.

The issuer host 108 may also include one or more communications interface devices 156, 158 for communicating with external devices or to receive external input. The I/O interface 158 may communicate with the data storage device 168 via a communications link 162. The data storage device 168 may be any mass storage device known in the art including, for example and without limitation, magnetic storage drives, a hard disk drive, optical storage devices, flash memory devices, or any suitable combination thereof. In accordance with one embodiment, the data storage device 168, illustrated in FIG. 1 as a database, may be configured to store account holder secure information 320 (e.g., virtual credit card information 322, predefined funding source 324, other identification associated with the user device 104, and the like), and the like. The data storage device 168 may further store information relating to merchant accounts 170 and issuer accounts 172 so as to enable the immediate reconciliation of payments due the merchant device 102 from transactions with the user device 104. The I/O interface 158 may further communicate with an associated user display 164 or input component 166, e.g., keyboard, mouse, etc., via a communications link 160.

The I/O interface 156 may communicate with the network 110 via the communications link 118, send a merchant application 218 to the merchant device 102, send a user application 316 to the user device 104, send a virtual credit card 326 to the user device 104, receive an authorization request 139 including transaction details 224 from the merchant acquiring host 108, communicate with one or more banks (not shown), and the like, as are discussed in greater detail below. The various components of the issuer host 108 may be all connected by a data/control bus 154. In one embodiment, the issuer host 108 is capable of processing closed-loop accounts (accounts that are only accepted at a single retailer or subset of retailers) or open loop (branded card, such as MASTERCARD, VISA, etc., acceptable wherever such brands are accepted). The issuer host 108 may provide end-to-end services, e.g., issuing, processing, and reconciliation operations. That is, the issuer host 108 may function as both issuer and merchant acquiring host 106, as discussed above.

According to one embodiment, the communications link 118 may include, for example and without limitation, 802.11a, 802.11b, 802.11g, 802.11(x), WiMax, LTE, Bluetooth, the public switched telephone network, GSM, CDMA, a proprietary communications network, infrared, optical, or any other suitable wired or wireless data transmission communications known in the art. Various network protocols, implementations or models may be used to facilitate communications amongst the various components illustrated in FIG. 1 including, for example and without limitation, TCP/IP, token rings, Ethernet, WAN, VLAN, WLAN, Internet, other packet-switching protocols, or the like.

The memory 146 may represent any type of non-transitory computer readable medium such as random access memory (RAM), read only memory (ROM), magnetic disk or tape, optical disk, flash memory, or holographic memory. In one embodiment, the memory 146 comprises a combination of random access memory and read only memory. In some embodiments, the processor 144 and memory 146 may be combined in a single chip. In another embodiment, the memory 146 may further correspond to any mass storage device(s), for example, magnetic storage drives, a hard disk drive, optical storage devices, flash memory devices, or a suitable combination thereof. The network interface(s) 156, 158 allow the issuer host 108 to communicate with other devices via the computer network 110, a cellular network, advanced cellular networks, personal area networks, and may comprise a modulator/demodulator (MODEM). Memory 146 may store data the processed in the method as well as the instructions 148 for performing the exemplary method.

The digital processor 144 can be variously embodied, such as by a single core processor, a dual core processor (or more generally by a multiple core processor), a digital processor and cooperating math coprocessor, a digital controller, or the like. The digital processor 144, in addition to controlling the operation of the issuer host 108, executes the instructions 148 stored in memory 146 for performing portions of the method outlined in FIGS. 4-9.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Turning now to FIG. 4, there is shown an exemplary method 400 for secure mobile transaction payments. The method 400 depicted in FIG. 4 represents the setup of secure mobile transaction payments on the merchant device 102. FIG. 5, discussed below, depicts a method 500 for setting up and enabling transactions with the merchant device 102, from the perspective of a user device 104. FIG. 6, discussed below, depicts an example method 600 for secure mobile transaction payments via the merchant device 102, in accordance with the systems and methods discussed herein. FIG. 7, discussed below, depicts an example method 700 for secure mobile transaction payments via the user device 104, in accordance with the systems and methods discussed herein. FIG. 8, discussed below, depicts an example method 800 for secure mobile transaction payments via the merchant acquiring host 106, in accordance with the systems and methods discussed herein. FIG. 9, discussed below, depicts an example method 900 for secure mobile transaction payments via the issuer host 108, in accordance with the systems and methods discussed herein.

The setup of the secure mobile transaction payment method 400 of FIG. 4 begins 402, whereupon a merchant, i.e., the merchant device 102, registers with the issuer host 108. In one embodiment, the merchant device 102 establishes a communications link with the issuer host 108 via respective communications links 112 and 118 over the network 110 to submit merchant information 230 to the issuer host 108. It will be appreciated that during such registration, the issuer host 108 may establish or setup a merchant account 170 associated with the merchant device 102, including any payment information (transaction settlement), contact information, merchant specific information, merchant type (e.g., restaurant, store, vendor, etc.), and the like.

The merchant device 102 may then download a merchant application 218 from the issuer host 108 at 404. In one embodiment, a standard application 218 is downloaded by the merchant device 102. In another embodiment, the issuer host 108 may generate a personalized merchant application 218 specific to the merchant device 102 and/or merchant associated therewith, specific to the type of merchant, or the like. It will be appreciated that the merchant application 218 may be specific to a particular operating system of the merchant device 102, such that multiple merchant applications 218 stored on the issuer host 108 may each be specific to iOS, ANDROID, BLACKBERRY, WINDOWS, etc. and communicated to the merchant device 102 utilizing such an operating system.

The merchant application 218 is then installed, at 406, in memory 206 of the merchant device 102. Subsequent to or contemporaneously with installation, the merchant device 102 may register with the merchant acquiring host 106 via the communications link 112 over the computer network 110 at 408. According to one embodiment, the merchant device 102 during registration may define certain parameters associated with the processing of transactions at 410. Such parameters may include, for example and without limitation, the type of merchant, the contact information of the merchant, and the like. Such parameters may further be stored in memory 122 of the merchant acquiring host 106 for use during facilitation of the settlement of transactions between the merchant device 102 and the user device 104, as discussed below. At 412, the merchant device 102 designates a merchant account 170 for settlement of transactions between the merchant device 102 and any of a plurality of user devices 104. Operations with respect to FIG. 4 then terminate and proceed to 602 of FIG. 6, as discussed below.

Turning now to FIG. 5, there is shown an exemplary method 500 for setting up the user device 104 to utilize the user application 316 for secure mobile transaction payments. At 502, the user device 104 downloads a user application 316 from the issuer host 108. As will be appreciated, the user application 316 may be specific to a particular operating system associated with the user device 104, and the issuer host 108 may store a plurality of different user applications 316 in memory 146 pertaining to those operating systems, e.g., iOS, ANDROID, BLACKBERRY, WINDOWS, etc. In some embodiments, the user application 316 may be stored on a third party server and downloadable via a central repository of applications, such as GOOGLE PLAY store, ITUNES, BLACKBERRY store, WINDOWS store, AMAZON store, or the like.

The user device 102, i.e., the processor 302 associated therewith, then installs the user application 316 into memory 304 at 504. The installation of the user application 316 on the user device 102 may include a plurality of different steps, each of which may be necessary to utilize the user application 316. For example, the installation performed at 504 may include registration of the user device 102 with the merchant acquiring host 106 and the issuer host 108. Such registration may require the establishment of a user account corresponding to account holder information 320, user identification (user and/or device specific), contact information, passwords, PINs, and the like. It will further be appreciated that such registration may be accomplished via the communications link 114 over the computer network 110 with the merchant acquiring host 106 and/or issuer host 108, or the like.

At 506, the user device 104 defines a funding source 324 for payment of transactions associate with the user device 104. It will be appreciated that the defining of the funding source 324 may occur during installation and setup of the user application 316 or subsequently after installation. According to one embodiment, the funding source 324 may correspond to any credit card, checking, debit, or other account from which the issuer host 108 may collect payment for transactions. Suitable examples may include AMERICAN EXPRESS, DISCOVER, MASTER CARD, VISA, and the like. In some embodiments, the funding source 324 may correspond to a user account previously associated with the issuer host 108. It will be appreciated that the predefined funding source 324 may be used to top up a virtual credit card 326 to be used in conducting the transactions, such that the user is unaware of the type of credit card use (e.g., MASTER CARD, VISA, etc.) for the transaction, instead only paying on the predefined funding source 324, e.g., an AMERICAN EXPRESS card.

A mobile wallet 322 is then initiated in memory 304 of the user device 104 in association with the user application 316 at 508. According to some embodiments, the mobile wallet 322 may be a separate from or integral with the user application 316. That is, the mobile wallet 322 may be implemented and function independent of the user application 316 and transactions conducted thereby. Such mobile wallet 322 may be implemented as set forth in co-pending U.S. patent application Ser. No. 13/533,057, the entirety of which is incorporated by reference herein. The mobile wallet 322 may further utilize a separate registration operation with the issuer host 108.

At 510, a branded virtual credit card 326 is received into the mobile wallet 322 stored in memory 304 of the user device 104. The branded virtual credit card 326 may be issued by the issuer host 108 in the form of a prepaid MASTER CARD, VISA card, AMERICAN EXPRESS card, or the like, having a set amount of funds on it from the predefined funding source 324. In some embodiments, the issuer host 108 may issue prepaid cards branded under a major credit card company, e.g., MASTER CARD, VISA, AMEX, etc., and facilitate the backend operations of topping up funds available on that prepaid card using the predefined funding source 324. In accordance with one embodiment, the virtual credit card 326 may be dynamically generated by the issuer host 108 in response to an authorization request 139 received from the merchant acquiring host 106, a request from the user application 316 of the user device 104, or the like. The dynamic issuance of the virtual credit card 326 may thus be generated for a specific transaction or a specific cost associated with a particular transaction. Operations with respect to FIG. 5 then progress to 702 of FIG. 7, wherein operation of the user device 104 during a transaction with the merchant device 102 is discussed.

Referring now to FIG. 6, there is shown an exemplary method 600 for use in mobile transaction payments with respect to the merchant device 104. The merchant device 102, such as a point of sale device, mobile device, workstation, or the like, first collects transaction details 224 at 602. As discussed above, transaction details 224 may include, for example, cost, items, totals, taxes, location, store number, and the like. For example, the transaction details 224 may include the name of an item, UPC code, retail price, discounts/coupons, tax, store identifier, and the like.

At 604, the payment information exchange selection is received corresponding to the type of exchange selected by the user of the user device 104 to receive transaction details 224. That is, the merchant device 102 receives a selection of the type of communication channel to utilize in communicating the transaction details 224 to the user device 104. As discussed above, the systems and methods set forth herein are capable of utilizing a plurality of different methods for communication of transaction details, e.g., the display of a code 226, a short-range communication protocol, an SMS message, an email message or other manner in which to communicate the transaction message 113, or the like. Accordingly, a determination is made at 606 whether wireless proximity communication is to be utilized. That is, whether the merchant device 102 and the user device 104 are to utilize a close range wireless communication link 111, such as NFC, BLUETOOTH, etc., to communicate the transaction details 224.

Upon a positive determination at 606, operations proceed to 608, whereupon the processor 202 in accordance with the transaction message generator 222 in the instructions 204 generates a transaction message 113. In accordance with one embodiment, the transaction message 113 may include the transaction details 224, merchant information 230, any extra fields (e.g., tips, etc.), hash key, timestamp, and the like. A communications link 111 is then established between the merchant device 102 and the user device 104 using the selected or applicable short-range communications protocol, e.g., NFC, BLUETOOTH, proprietary channel, infrared, etc. The merchant device 102 then communicates the transaction message 113 to the user device 104 via the communications link 111 at 612. Operations then proceed to 708 of FIG. 7.

Upon a determination at 606 that a wireless communication method has not been selected, operations proceed to 614. At 614, the processor 202 in accordance with the code generator 220 stored in the instructions 204 of memory 206 generates a unique code corresponding to the transaction currently underway between the merchant device 102 and the user device 104. In accordance with one embodiment, the code generator 220 is operable to generate a unique machine-readable code 226, e.g., a QR code, DatGlyph, barcode, etc., which suitably encodes the transaction details 224, merchant information 230, extra fields, timestamp, hash key, and the like. It will be appreciated that the code 226 may visually represent the information contained in the transaction message 113 referenced above.

The merchant device 102 may then display the machine-readable code 226 at 616 via the display 214. In some embodiments, the merchant device 102 utilizing an associated printer, may output a tangible receipt containing the machine-readable code 226 for use by the user device 104. Operations then proceed to 712 of FIG. 7 for continuing of the transaction initiated in FIG. 6.

FIG. 7 illustrates an exemplary method 700 utilized by the user device 104 for mobile transaction payments. Operations with respect to FIG. 7 begin at 702, whereupon the payment information exchange type is selected. As discussed with respect to FIG. 6, the payment information exchange type may be selected from a short-range communications protocol, a display of machine-readable code, email, SMS messaging, or the like. It will be appreciated that while the example implementation discussed herein utilizes a short-range communication protocol or code display, other forms of wired or wireless methods for communicating the transaction details 224 to the user device 104 may also be utilized in accordance with the systems and methods set forth herein.

A determination is then made at 704 whether a wireless exchange type has been selected. Upon a positive determination at 704, operations proceed to 706, whereupon a short-range communications channel 111 is established between the user device 104 and the merchant device 102. It will be appreciated that such link 111 may utilize a proprietary communication connection, an NFC communication, a BLUETOOTH communication, infrared communication, or the like. A transaction message 113 is then received by the user device 104 over the established communications link 111 at 708 (from 612 of FIG. 6), following which the transaction details 224 contained in the transaction message 113 are displayed via the display 308 of the user device 104 at 716.

Returning to 704, upon a determination that a wireless communication exchange is not selected, operations proceed to 710. At 710, the processor 302 in accordance with the user application 316 initiates the image capture component 314. The image capture component 314 then scans the machine-readable code 226 at 712 (from 616 of FIG. 6). The decoder 318 stored in memory 304 of the user device 104 then decodes machine-readable code 226 at 714. It will be appreciated that such decoder 318 is suitably configured to read the type of code 226 utilized in accordance with the implementation, i.e., when the code 226 is implemented as a QR code or DatGlyph, the decoder 318 is configured to read and interpret QR codes or DatGlyphs. The transaction details 224 and other information previously encoded in the code 226 by the merchant device 102 are then displayed to the user via the display 308 of the user device 104 at 716.

At 718, the user associated with the user device 104 is prompted to confirm the transaction details 224 displayed on the user device display 308. In one embodiment, the prompt at 718 includes a prompt for the user to input a suitable tip or fill in other necessary fields associated with the transaction. Following confirmation, operations proceed to 720, whereupon payment selection is received from the user corresponding to a desired payment account or card selection. It will be appreciated that the user may be presented with choices for payment of the transaction, such as the predefined funding source 324, the virtual credit card 326, or other account information. At 722, the user may optionally input a PIN associated with the account or card selected.

The mobile wallet 322 associated with the user device 104 may then be initiated at 724 and used to determine the appropriate account holder secure information 320 (e.g., the virtual card 326, user identification, etc.) for communication to the merchant acquiring host 106 in accordance with the selected payment form at 726. The merchant acquiring message generator 328 resident in memory 304 may then be used to generate a merchant acquiring message 330 containing the transaction details 224, the merchant information 230, and the account holder secure information 320 at 728.

The merchant acquiring message 330 may then be communicated at 730 to the merchant acquiring host 106 via the communication link 114 over the computer network 110. Operations with respect to the transaction being processed in FIG. 7 then proceed to 802 of FIG. 8.

FIG. 8 illustrates an exemplary method 800 utilized by the merchant acquiring host 106 for mobile transaction payments in accordance with one aspect of the subject disclosure. At 802, the merchant acquiring host 106 receives a merchant acquiring message 330 from the user device 104 via the communications 116 over the computer network 110. As discussed above, the merchant acquiring message 330 may include transaction details 224, merchant information 230, and account holder secure information 320. At 804, the processor 120 or other suitable component associated with the merchant acquiring host 106 processes the received merchant acquiring message 330 in accordance with instructions 124 stored in memory 122 to determine the payment account for the transaction at 804. That is, the merchant acquiring host 106 processes the account holder secure information 320 to identify the credit card or other account information necessary to facilitate settlement of the transaction between the user device 104 and the merchant device 102.

At 806, the issuer host 108 associated with the determined payment account is identified. It will be appreciated that the issuer host 108 may be identified based upon the credit card number or account number, which may include indicia corresponding to a certain issuer, bank, or the like. Following identification of the correct issuer host 108, operations proceed to 808 whereupon the merchant acquiring host 106 in accordance with the authorization request component 138 generates a payment authorization request 139 inclusive of the account holder secure information 320, the merchant information 230, and some or all of the transaction details 224. The payment authorization request 139 is then communicated to the identified issuer host 108 at 810. In one embodiment, a transaction status component 140 resident in the instructions 124 of memory 122 may facilitate the generation and communication of transaction status 142 to both the merchant device 102 and the user device 104. Such transaction status 142 may be continuously sent to the devices 102 and 104 as information is received from the issuer host 108 and include, for example, status information that reflects a payment request 139 has been submitted, authorization is pending, response received, no response received, etc. After communication of the payment authorization request 139 to the issuer host 108, operations with respect to FIG. 8 proceed to 902 of FIG. 9.

Turning now to FIG. 9, there is shown an exemplary method 900 of the issuer host 108 for mobile transaction payments in accordance with one embodiment contemplated herein. At 902, a payment authorization request 139 is received from the merchant acquiring host 106 corresponding to a transaction between the merchant device 102 and the user device 104. The account holder secure information 320 is retrieved from the request 139 at 904. A determination is then made at 906 whether to authorize payment in response to the received authorization request 139. In accordance with one embodiment, an authorization component 152 in instructions 148 of the memory 146 of the issuer host 108 retrieves account holder secure information 320 in data store 168 to determine whether funds are available to process the transaction set forth in the transaction details 224. That is, the issuer host 108 determines whether the transaction should be approved based upon the available credit or funds associated with the user account identified by the secure information 320.

Upon a negative determination at 906, e.g., insufficient funds, predefined funding source 324 expired or invalid, etc., operations proceed to 908, whereupon a denial message is generated in response to the authorization request 139. At 916, the denial message is communicated to the merchant acquiring host 106 via the communications link 118 over the computer network 110. As previously discussed, although illustrated in FIGS. 1-9 as separate entities, the merchant acquiring host 106 and issuer host 108 may be implemented as the same entity, on the same device, or the like, and the depiction of two distinct entities is shown for purposes of illustration only.

Returning to 906, upon a determination to authorize the payment, operations proceed to 910, whereupon the merchant account 170 associated with the merchant information 230 contained in the authorization request 139 is credited with the amount necessary to settle the transaction between the merchant device 102 and the user device 104. At 912, the user account in issuer accounts 172 is debited/charged corresponding to the amount credited to the merchant account 170. The issuer host 108 then generates an authorization message (e.g., confirmation number, authorization number, totals, etc.) at 914 corresponding to the successful settlement of accounts 170 and 172 pursuant to the transaction between the merchant device 102 and the user device 104. Operations then proceed to 916, whereupon the authorization message is communicated to the merchant acquiring host 106. Operations then return to 812 of FIG. 8 with respect to the merchant acquiring host 106 completing the transaction between the merchant device 102 and the user device 104.

At 812 of FIG. 8, the authorization or denial message is received by the merchant acquiring host 106 from the issuer host 108. The merchant acquiring host 106 then communicates authorization or denial of the transaction identified in the transaction details 224 to both the merchant device 102 and the user device 104 at 814. Operations with respect to FIG. 8 and the merchant acquiring host 106 thereafter terminate.

Returning to FIGS. 6 and 7, the authorization or denial from the merchant acquiring host 106 is respectively received at 618 and 732 by the merchant device 102 and the user device 104. The merchant device 102 thereafter displays the status 142 of the transaction indicating either the approval or denial thereof at 620, whereafter operations with respect to the merchant device 102 terminate. Similarly, the user device 104 displays the status 142 of the transaction indicating the approval or denial of the transaction via the display 308, thereafter operations with respect to the user device 104 terminate.

The method illustrated in FIGS. 4-9 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 4-9, can be used to implement the method estimating origins and destinations for users of a transportation system.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for mobile transaction payments, comprising:
receiving, by a user device, merchant information and transaction details corresponding to a transaction between an associated merchant and an associated user;
generating a merchant acquiring message inclusive of the transaction details, the merchant information, and account holder secure information corresponding to the associated user;
communicating the merchant acquiring message to a merchant acquiring host via an associated computer network;
receiving a response from the merchant acquiring host corresponding to at least one of an authorization or denial of the transaction; and
displaying, via an associated display, a status of the transaction in accordance with the received authorization or denial of the transaction,
wherein at least one of the receiving, generating, communicating, receiving, and displaying is performed with a computer processor of the user device.

2. The method of claim 1, wherein the transaction details are generated via a merchant application operative on an associated merchant device.

3. The method of claim 2, wherein receiving the transaction details further comprises:
scanning, via an image capture component of the user device, a machine-readable code displayed on an associated merchant device, the machine-readable code encoding the transaction details and merchant information therein; and
decoding the machine-readable code to determine the transaction details and merchant information encoded therein.

4. The method of claim 3, wherein the machine-readable code is a QR code, a dataglyph, a proprietary machine-readable code, or a barcode.

5. The method of claim 2, wherein generating the merchant acquiring message further comprises:
initiating a mobile wallet having a virtual credit card issued by an issuer host stored therein;
receiving payment selection information from the associated user corresponding to at least one of the virtual credit card or a predefined funding source;
generating the merchant acquiring message in accordance with the received payment selection information and the decoded transaction details and merchant information.

6. The method of claim 5, further comprising:
displaying, via the associated display of the user device, the received transaction details and merchant information; and
receiving input from the associated user corresponding to a confirmation of the transaction associated with the transaction details; and
generating the merchant acquiring message in response to a received confirmation input from the associated user.

7. The method of claim 6, wherein the virtual credit card is a credit card, a charge card, or a prepaid card issued by the issuer host.

8. The method of claim 7, wherein the predefined funding source includes at least one of a checking account, a credit card account, a debit card account, a charge card account, or a savings account.

9. The method of claim 2, wherein receiving the transaction details further comprises:
establishing a short-range communications link between the user device and the associated merchant device; and
receiving a transaction message from the associated merchant device via the short-range communications link, wherein the transaction message includes the transaction details and the merchant information.

10. The method of claim 9, wherein the short-range communications link is selected from the group consisting of near field communications link, a BLUETOOTH communications link, and an infrared communications link.

11. A computer program product comprising a non-transitory recording medium storing instructions, which when executed on a computer causes the computer to perform the method of claim 1.

12. A system comprising memory storing instructions for performing the method of claim 1, and a processor in communication with the memory which implements the instructions.

13. A mobile transaction payment system, comprising:
a merchant acquiring host, including:
an authorization request component configured to generate an authorization request to an associated issuer host for a transaction between an associated merchant device and an associated user device;
memory which stores instructions for:
receiving a merchant acquiring message from the associated user device, the merchant acquiring message including transaction details, merchant information and account holder secure information,
identifying the associated issuer host in accordance with the account holder secure information of the merchant acquiring message,
generating the authorization request to the identified issuer host corresponding to the transaction details, merchant information, and account holder secure information, and
communicating authorization or denial of the transaction associated with the transaction details to the associated merchant device and the associated user device; and
a processor in communication with the memory which executes the instructions.

14. The mobile transaction payment system of claim 13, further comprising a transaction status component configured to communicate status information associated with the transaction between the associated merchant device and the associated user device.

15. The mobile transaction payment system of claim 14, wherein the issuer host comprises:
an authorization component configured to authorize a transaction between the merchant device and the user;
memory storing a merchant account, an issuer account, and account holder secure information; and
a processor in communication with the memory, wherein the memory stores instructions executed by the processor for:
receiving an authorization request from the merchant acquiring host corresponding to the transaction between the merchant device and the user device,
retrieving account holder secure information in accordance with the received authorization request,
generating an authorization message corresponding to at least one of an authorization or a denial of the transaction, and
communicating the authorization message to the merchant acquiring host.

16. The mobile transaction payment system of claim 15, wherein the issuer host further comprises a virtual credit card issuing component configured to issue a virtual credit card in response to a registration of the associated user device and to associate funds from a predefined funding source of the user with the virtual credit card.

17. The mobile transaction payment system of claim 16, wherein the issuer host further comprises:
a merchant application stored in memory and configured to direct operations of the associated merchant device upon installation thereon; and
a user application stored in memory and configured to direct operations of the associated user device upon installation thereon;

18. The mobile transaction payment system of claim 17, wherein the memory further stores instructions for:
crediting the merchant account in accordance with an authorization of the transaction; and
debiting the issuer account in accordance with the crediting of the merchant account.

19. The mobile payment transaction system of claim 14, wherein the associated merchant device comprises:
a code generator configured to generate a machine-readable code encoding the transaction details and merchant information;
memory storing the transaction details and merchant information; and
a processor in communication with the memory, wherein the memory stores instructions executed by the processor for:
collecting the transaction details corresponding to the transaction between the merchant device and the associated user device;
generating a machine-readable code corresponding to the collected transaction details and the merchant information,
displaying the generated machine-readable code via an associated display,
receiving at least one of an authorization or a denial of the transaction from the merchant acquiring host, and
displaying the status of the transaction.

20. The mobile transaction payment system of claim 19, wherein the associated merchant device further comprises:
a transaction message generator configured to generate a transaction message inclusive of the transaction details and merchant information, and
wherein the memory further stores instructions which are executed by the processor for:
generating a transaction message including the transaction details and merchant information, and
communicating the generated transaction message to the associated user device via a short-range communication link.

21. The mobile transaction payment system of claim 20, wherein the associated user device comprises:
an image capture component configured to scan the machine-readable code displayed on the display associated with the merchant device;
a decoder configured to decode the machine-readable code to determine the transaction details and merchant information encoded therein;
a merchant acquiring message generator configured to generate the merchant acquiring message;
memory storing the account holder secure information and the virtual credit card;
memory which stores instructions for:
determining the transaction details and the merchant information from a scan of the machine-readable code by the image capture component,
generating the merchant acquiring message in accordance with the transaction details, the merchant information, and the account holder secure information, and
communicating the generated merchant acquiring message to the merchant acquiring host; and
a processor in communication with the memory which executes the instructions.

22. The mobile transaction payment system of claim 21, wherein the user device memory further stores instructions for:
receiving a response from the merchant acquiring host corresponding to at least one of an authorization or denial of the transaction, and
displaying, via an associated display, a status of the transaction in accordance with the received authorization or denial of the transaction.

23. The mobile transaction payment system of claim 22, wherein the user device memory further stores instructions for:
establishing a short-range communications link between the user device and the associated merchant device; and
receiving a transaction message from the associated merchant device via the short-range communications link, wherein the transaction message includes the transaction details and the merchant information.

24. A computer-implemented mobile payment transaction method, comprising:
collecting, by a merchant device having a processor and memory storing merchant information corresponding to an associated merchant, at least one transaction detail corresponding to a transaction between the associated merchant and an associated user;
generating a machine-readable code corresponding to the at least one collected transaction detail and the merchant information;
displaying the generated machine-readable code via an associated display;
receiving at least one of an authorization or a denial of the transaction from an associated merchant acquiring host; and
displaying the status of the transaction.

25. The computer-implemented method of claim 25, further comprising:
generating a transaction message including the transaction details and merchant information; and
communicating the generated transaction message to the associated user device via a short-range communication link.

26. A merchant device comprising memory storing instructions for performing the computer-implemented method of claim 25, and a processor in communication with the memory which implements the instructions.
